(19) United States
(12) Patent Application Publication
(10) Pub. No.: US 2007/0052201 A1
(43) Pub. Date: Mar. 8, 2007

(54) Bicycle pedal

(76) Inventors: Frank Hermansen, Laguna Beach, CA (US); Carl Winefordner, Laguna Beach, CA (US)

Correspondence Address: Leonard Tachner, a professional law corporation;Suite 38-E, 17961 Sky Park Circle, California, CA, 92614, US

(21) Appl. No.: 11/220,096

(22) Filed: Sep. 6, 2005

(51) Int. Cl. B62K 21/00

(52) U.S. Cl. 280/279

(57) ABSTRACT

A steering bearing assembly is comprised of two bearing assemblies and a preload assembly. Each bearing assembly is comprised of two rings, a cartridge bearing, and a seal. Each ring has an annular flange to contact and support the cartridge bearings. The outer diameter of the rings is substantially the same as the outer diameter of the cartridge bearings. The majority of the exterior radial surface of the cartridge bearings is exposed after the bearing assemblies are installed. This design substantially reduces the amount of material needed to build a robust headset, improves aerodynamics, and improves aesthetics. A novel preload assembly is comprised of a threaded cap with an integral thread, two expansion shells, an o-ring, and an expansion split ring. The thread on the threaded cap is tapered so that the shells are expanded when the cap is tightened. A stem is clamped to the steerer tube after the system is preloaded. Thus, the handlebars are connected to the fork, so that the front wheel can be turned by turning the handlebars.

### BACKGROUND OF THE INVENTION

1. Field of the Invention

This invention relates in general to bicycles. In particular, the invention relates to an improved assembly for connecting the front wheel and handlebars to the frame of a bicycle.

2. Background Art

In some prior art bicycles, the front wheel and the handlebars are connected to a steerer tube. The steerer tube passes through a head tube connected to the bicycle frame. Ball bearing assemblies, located at the upper and lower ends of the head tube, allow the steerer tube to pivot within the head tube. Collectively, this bearing system is called the “headset”.

Until Rader's headset disclosed in U.S. Pat. No. 5,095,770, typically the upper end of the steerer tube was threaded externally. An internally threaded lock nut was placed on the steerer tube and tightened until the lock nut secures the upper race of the upper bearing assembly downward against the lower race. Because of the many advantages; currently, most bicycle headsets now use some form of Rader's invention, where the steer tube is not threaded. Instead a mechanism preloads the bearings, and the stem is clamped to the steer tube. This is typically called a “threadless” headset.

For durability the races must be made from very hard steel, or similar, and for weight reasons races are typically retained in aluminum receptors (cups) having annular chambers which are connected to the head tube. Therefore, the outer diameter of the cups is always larger than the outer diameter of the bearing races.

With the introduction of cartridge bearings, this basic assembly was simply duplicated. Cartridge bearings were retained in the annular chamber of the aluminum cups, and against a flange on the other side. A cartridge bearing by definition is a self-contained unit, and therefore does not require additional walls to retain the races and bearing balls. Cups which enclose the cartridge bearings add unnecessary weight, complexity and cost. In addition a gap or a peripheral opening is formed between the cup and the flange creating an opening which must be sealed to prevent dirt or contaminant or liquid, from entering into the ball bearing and cause rust and damage to the ball bearing. The cup shape is particularly unfortunate in the upper bearing assembly, as this creates a reservoir that holds water, which can accelerate corrosion. The present invention provides an improved steering bearing assembly having cartridge bearings, without inadvertently providing an opening subject to contamination.

Over the past thirty years, cartridge bearings have become increasingly more commonly used on many areas of the bicycle: pedals, frame suspensions, hubs, bottom brackets, and headsets. Cartridge bearings are much easier to replace than loose ball systems, are often sealed, and are available in a variety of materials and precision levels.

When used in headsets, cartridge bearings often have a beveled edge on one side of the inner race and another beveled edge on the other side of the outer race. Typically, angled flanges contact and support the beveled edges of the cartridge bearings to keep them concentric and supported. One of the two angled flanges is always within a cup that surrounds the cartridge bearing. This means that the cartridge bearing is always hidden, similar to the way that loose balls were encased between two races. Consequently, the cups on threadless type headsets always have a bigger diameter than that of the cartridge bearing.

Unfortunately, encasing the cartridge bearing within a cup is a waste of material, is aesthetically unappealing, and causes more wind drag. Also, depending on the orientation of the cups, contamination including water can collect in the cup, causing bearing corrosion. The main difference between an expensive and an inexpensive headset is found in the characteristics of the bearing system. Because of the cups of prior art headsets, this is a “hidden” feature. For example, an inexpensive headset with loose ball bearings retailing for 20 dollars looks basically identical to an expensive headset with sealed high precision cartridge bearings costing 120 dollars. It would be advantageous for both manufacturers and consumers that this main feature (the cartridge bearings) is visible. Other shortcomings of the prior art are apparent to those skilled in the art.

For preloading the bearings, typically there is a star nut that grabs the inside of the steerer tube, a cap that sits on top of the stem, and a screw that pulls the cap towards the star nut. The cap and screw are always separate components, and the screw has a thread diameter of 6mm or less. This system works well for aluminum or steel steerer tubes, although it is relatively heavy at about 35 grams. Star nuts can damage the inside of carbon fiber steerer tubes, so in that case some form of expansion nut is used instead, but is also relatively heavy at about 50 grams and also costly. Also, star nuts require special tools to be installed into the steerer tube, and are generally considered permanently installed.

### SUMMARY OF THE INVENTION

The main objective of the present invention is to provide a steering bearing assembly for a bicycle frame, which is lightweight, aesthetically pleasing, easy to seal, inexpensive to produce, and provides improved aerodynamics. According to the present invention, the steering bearing assembly includes a head tube connected to a bicycle frame, a steerer tube connected to a front wheel fork and passing through the head tube. The upper bearing assembly includes a first ring connected to the upper end of the head tube, the first ring having an annular flange for contact with a first race of a cartridge bearing, a cartridge bearing, and an upper ring having an annular flange for contact with a second race of the cartridge bearing. The outer race of the cartridge bearing is sealed on the top side by the upper ring, and by a seal on the bottom side that fits between the outer race and the first ring.

The lower bearing assembly includes a first ring connected to the lower end of the head tube, the first ring having an annular flange for contact with a first race of a cartridge bearing, a cartridge bearing, and a lower ring having an annular flange for contact with the second race of the cartridge bearing. The outer diameter of the rings is substantially the same or smaller compared to the outer diameter of the cartridge bearings. The upper and lower bearing assemblies permit relative rotation of the steerer tube in relation to the head tube. The outer race of the cartridge bearing is sealed on the top side by the first ring, and by a seal on the bottom side that fits between the outer race and the lower ring. Secondarily, the cartridge bearing itself can have seals built in.

A preload assembly includes a threaded cap, an o-ring, an expansion ring, and two expansion shells with threads that engage the threads of the cap. The cap thread has an OD larger than 10 mm. The thread of the cap and/or the thread of the expansion shells is/are conical so that the cap expands the expansion shells as the cap is tightened.

Compared to a traditional Threadless type headset, and assuming the same cartridge bearings are used, this novel headset can use about 40% less material, resulting in a reduced overall headset weight of more than 20%. For example, not including the preload assembly, a typical Threadless headset that weighs 100 grams, will weigh only about 75 grams using this novel approach, without any reduction in strength or durability. Additionally, this novel headset is better sealed, has reduced wind resistance, is aesthetically more appealing, and displays the outer race of the cartridge bearing. The preload assembly of this novel headset saves both weight and cost. Traditional preload assemblies typically weigh between 35 and 50 grams, while this novel preload assembly weighs only about 19 grams when using an aluminum threaded cap, thermoplastic expansion shells, and a steel expansion ring.

### BRIEF DESCRIPTION OF THE DRAWINGS

The aforementioned objects and advantages of the present invention, as well as additional objects and advantages thereof will be more fully understood hereinafter, as a result of a detailed description of preferred embodiments thereof, when taken in conjunction with the following drawings in which:

FIG. 1 is an exploded perspective view of the front end of a bicycle incorporating a prior art steering bearing assembly with loose ball bearings;

FIG. 2 is an exploded perspective view of the front end of a bicycle incorporating a prior art steering bearing assembly with cartridge bearings;

FIG. 3 is an assembled front view of the prior art steering bearing assembly shown FIG. 1;

FIG. 4 is a side view of the prior art steering bearing assembly shown in FIG. 3;

FIG. 5 is the assembled front view of the prior art steering bearing assembly shown FIG. 2;

FIG. 6 is a side view of the prior art steering bearing assembly shown in FIG. 5;

FIG. 7 is a cross sectional view of the prior art steering bearing assembly shown in FIG. 4;

FIG. 8 is a cross sectional view of the prior art steering bearing assembly shown in FIG. 6;

FIG. 9 is a front view of the preferred embodiment;

FIG. 10 is an exploded perspective view of the front end of a bicycle incorporating the steering bearing assembly in accordance with the preferred embodiment;

FIG. 11 is an assembled front view of the steering bearing assembly shown FIG. 10;

FIG. 12 is a side view of the steering bearing assembly shown in FIG. 11;

FIG. 13 is a cross sectional view of the steering bearing assembly shown in FIG. 12;

FIG. 14 is a front view of an alternative embodiment preload assembly;

FIG. 15 is an exploded perspective view of the alternative embodiment preload assembly shown in FIG. 14;

FIG. 16 is a cross sectional view of the alternative embodiment preload assembly shown in FIG. 14.

The description herein refers to reference numerals in the accompanying drawings and these reference numerals refer to the parts therein having the following definitions:

REFERENCE NUMERALS IN DRAWINGS

| | | | |
|---|---|---|---|
| 10 | headset | 20 | screw |
| 30 | cap | 40 | star nut |
| 50 | stem | 60 | screw |
| 70 | screw | 80 | screw |
| 90 | compression split ring | 100 | second race |
| 110 | ball bearings | 120 | first race |
| 130 | cup | 132 | annular flange |
| 134 | outer region | 140 | head tube |
| 150 | cup | 152 | annular flange |
| 154 | outer region | 160 | first race |
| 170 | second race | 180 | fork |
| 182 | steerer tube | 184 | crown |
| 186 | blade | 188 | blade |
| 200 | cartridge bearing | 202 | surface |
| 204 | surface | 206 | outer race |
| 210 | ring | 212 | annular flange |
| 220 | upper bearing assembly | 230 | lower bearing assembly |
| 240 | upper bearing assembly | 250 | lower bearing assembly |
| 260 | ring | 262 | annular flange |
| 270 | o-ring | 280 | threaded cap |
| 282 | hex | 284 | thread |
| 290 | o-ring | 300 | expansion shell |
| 306 | thread | 310 | expansion shell |
| 312 | groove | 314 | recess |
| 316 | thread | 320 | expansion split ring |
| 330 | ring | 332 | annular flange |
| 340 | seal | 350 | ring |
| 352 | annular flange | 360 | ring |
| 362 | annular flange | 370 | ring |
| 372 | annular flange | 380 | upper bearing assembly |
| 390 | lower bearing assembly | 400 | preload assembly |
| 410 | preload assembly | 430 | cup |
| 450 | cup | 460 | alternative embodiment |
| | | | preload assembly |
| 470 | threaded cap | 480 | rubber band |
| 482 | rib | 484 | rib |
| 486 | thread | | |

### DETAILED DESCRIPTION OF PREFERRED EMBODIMENT

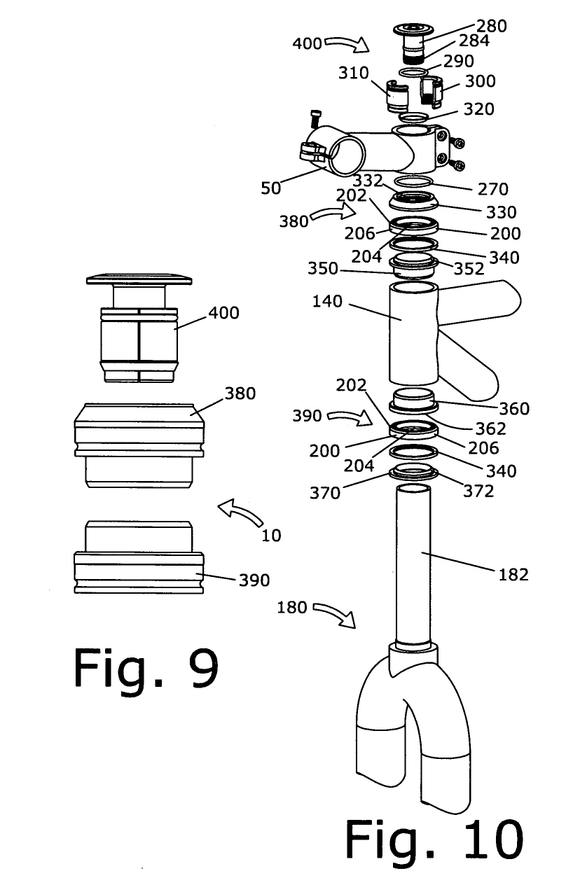

The steering bearing assembly of the invention is intended for use on wheeled vehicles. FIG. 9 shows the novel lower bearing assembly, upper bearing assembly, and preload adjustment assemblies.

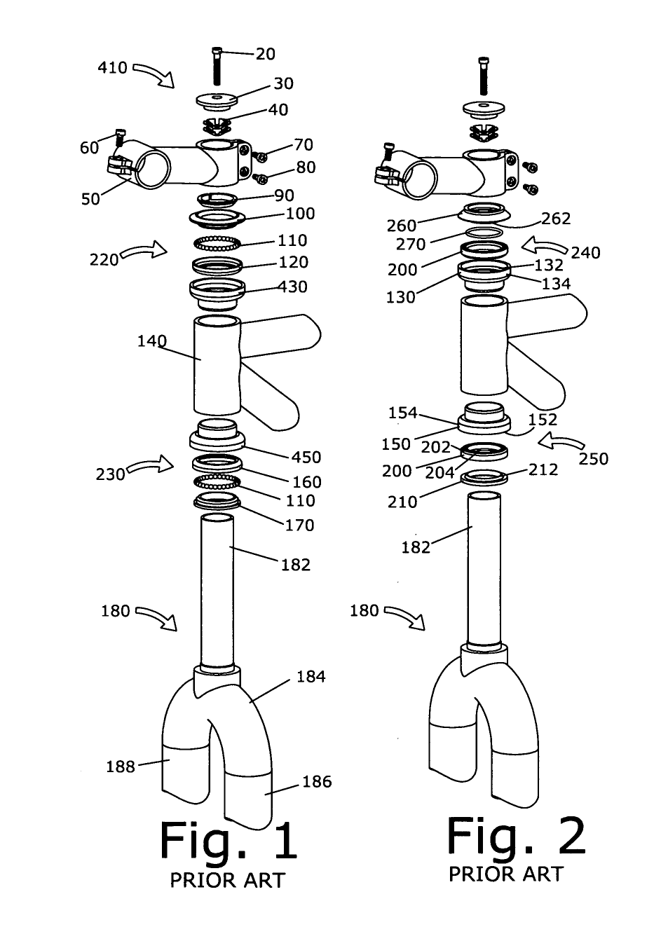

FIG. 1 is a front end view of a bicycle incorporating a prior art steering bearing assembly with loose ball bearings. A typical prior art fork 180 has a steerer tube 182, a crown 184, and blades 186 and 188 for attachment to a wheel hub (not shown). A lower bearing assembly 230 comprises a cup 450, a first race 160, ball bearings 110, and a second race 170. Race 170 is press fit onto steerer tube 182 and cup 450 is press fit into the bottom of head tube 140. An upper bearing assembly 220 comprises a cup 430, a first race 120, ball bearings 110, a second race 100, and a compression split ring 90. Cup 430 is press fit into the top of head tube 140.

A stem 50 is fit around steerer tube 182 and on top of compression split ring 90. A preload assembly 410 comprises of a screw 20, a cap 30, and a star nut 40. Star nut 40 is press fit into steerer tube 182. When screw 20 is tightened, cap 30 pulls fork 180 upwards and preloads the upper and lower bearing assemblies 220 and 230. As is usually the case in prior art preload assemblies, screw 20 is made of steel or titanium and is a separate component from cap 30, and screw 20 has a shaft and thread diameter of 6 mm or less. Screw 20 is not made of aluminum because the diameter is too small to be sufficiently strong. Then screw 70 and 80 are tightened to clamp stem 50 to steerer tube 182. Screw 60 secures a handlebar (not shown) to stem 50. Thus, the handle bars are connected to fork 180 so that the front wheel can be turned by turning the handle bars.

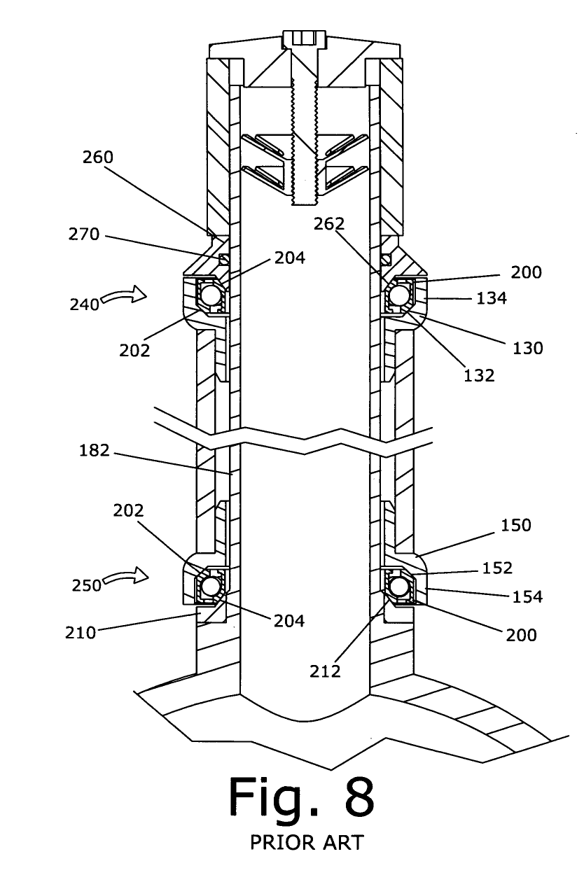

FIG. 2 is a front end view of a bicycle incorporating a prior art steering bearing assembly with cartridge bearings. A lower bearing assembly 250 comprises of a cup 150, a cartridge bearing 200, and a ring 210. An upper bearing assembly 240 comprises of a cup 130, a cartridge bearing 200, a ring 260 and an o-ring 270. Ring 210 has an annular flange 212 that contacts bearing surface 204 and cup 150 has an annular flange 152 to contact bearing surface 202 (better shown in FIG. 8). Similarly, ring 260 has an annular flange 262 that contacts bearing surface 204 and cup 130 has an annular flange 132 to contact bearing surface 202 (better shown in FIG. 8). Note that the outer regions 134 and 154 are excess material because they do not support cartridge bearings 200. The upper and lower bearing assemblies 240 and 250 are preloaded and clamped in a manner that is similar to the loose ball system shown in FIG. 1, except that instead of a compression split ring 90, an o-ring 270 provides a snug fit between ring 260 and steerer tube 182. Thus, the handle bars are connected to fork 180 so that the front wheel can be turned by turning the handle bars.

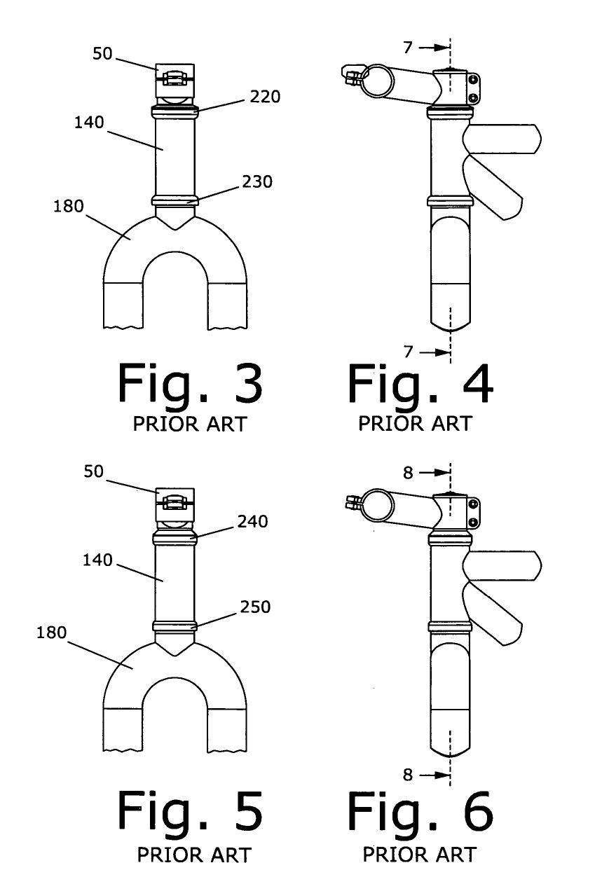

FIG. 3 is a front view of the prior art assembled steering bearing assembly shown FIG. 1. Stem 50, upper bearing assembly 220, head tube 140, lower bearing assembly 230, and fork 180 can be seen. Note that the outer diameter of bearing assemblies 220 and 230 is larger than the outer diameter of head tube 140.

FIG. 4 is a side view of the prior art steering bearing assembly shown in FIG. 3.

FIG. 5 is a front view of the prior art assembled steering bearing assembly shown FIG. 2. Stem 50, upper bearing assembly 240, head tube 140, lower bearing assembly 250, and fork 180 can be seen. Note that the outer diameter of bearing assemblies 240 and 250 is larger than the outer diameter of head tube 140.

FIG. 6 is a side view of the prior art steering bearing assembly shown in FIG. 5.

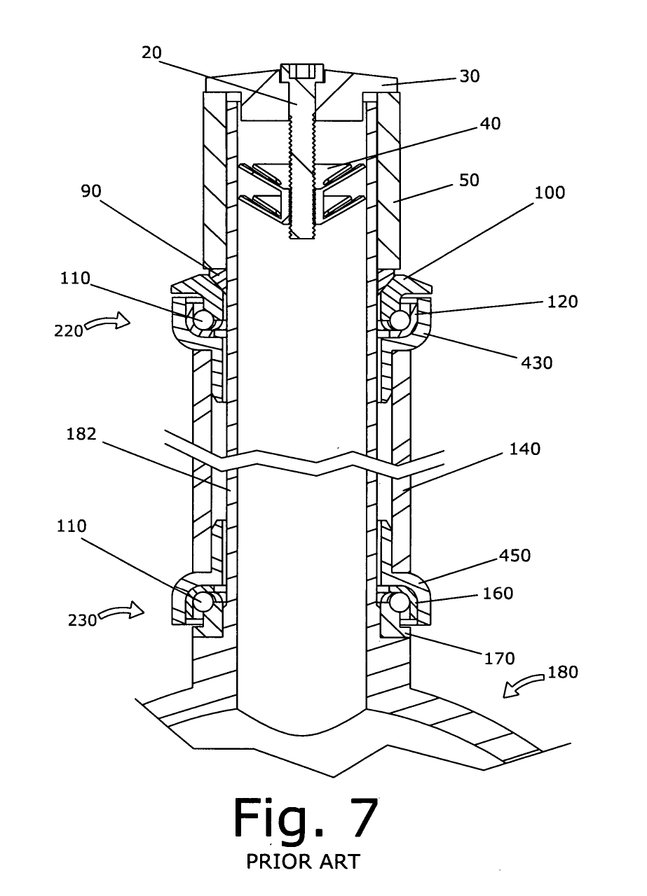

FIG. 7 is a cross sectional view of the prior art steering bearing assembly shown in FIG. 4. Second race 170 is press fit onto steerer tube 182 and cup 450 is press fit into the bottom of head tube 140. Bearings 110 fit between first race 160 and second race 170. Cup 430 is press fit into the top of head tube 140. Bearings 110 fit between first race 120 and second race 100. Compression split ring 90 fits around steerer tube 182 and between second race 100 and stem 50. When screw 20 is tightened, cap 30 pulls star nut 40 upwards, which pulls fork 180 upwards and preloads the upper and lower bearing assemblies 220 and 230.

FIG. 8 is a cross sectional view of the prior art steering bearing assembly shown in FIG. 6. Ring 210 is press fit onto steerer tube 182 and has an annular flange 212 that contacts bearing surface 204. Cup 150 has an annular flange 152 to contact bearing surface 202. Similarly, ring 260 has an annular flange 262 that contacts bearing surface 204 and cup 130 has an annular flange 132 to contact bearing surface 202. Note that the outer regions 134 and 154 are excess material because they do not support cartridge bearings 200. The upper and lower bearing assemblies 240 and 250 are preloaded and clamped in a manner that is similar to the loose ball system shown in FIG. 1, except that instead of a compression split ring 90, an o-ring 270 provides a snug fit between ring 260 and steerer tube 182.

FIG. 9 is a front view of the headset 10. Headset 10 comprises of a lower bearing assembly 390, and an upper bearing assembly 380, and a preload assembly 400.

FIG. 10 is an exploded view of a bicycle incorporating the steering bearing assembly of the invention in accordance with the preferred embodiment 10. A lower bearing assembly 390 comprises a ring 360, a cartridge bearing 200, a seal 340, and a ring 370. Preferably, the at least the outer race 206 of cartridge bearing 200 should be made of a non-corrosive material such as stainless steel or titanium or ceramic, or should be plated for corrosion protection. An upper bearing assembly 380 comprises a ring 350, a seal 340, a cartridge bearing 200, a ring 330, and an o-ring 270. Similar to the prior art shown in FIG. 2, o-ring 270 provides a snug fit between ring 330 and steerer tube 182.

Ring 370 has an annular flange 372 that contacts bearing surface 204 and ring 360 has an annular flange 362 to contact bearing surface 202. Similarly, ring 330 has an annular flange 332 that contacts bearing surface 202 and ring 350 has an annular flange 352 to contact bearing surface 204. Note that the largest diameter of rings 330, 350, 360, and 370 is substantially the same as the outer diameter of the cartridge bearings 200 and head tube 140. This design substantially reduces the amount of material needed to build a robust headset. Also note that after assembly, the outer race of cartridge bearings 200 will be exposed.

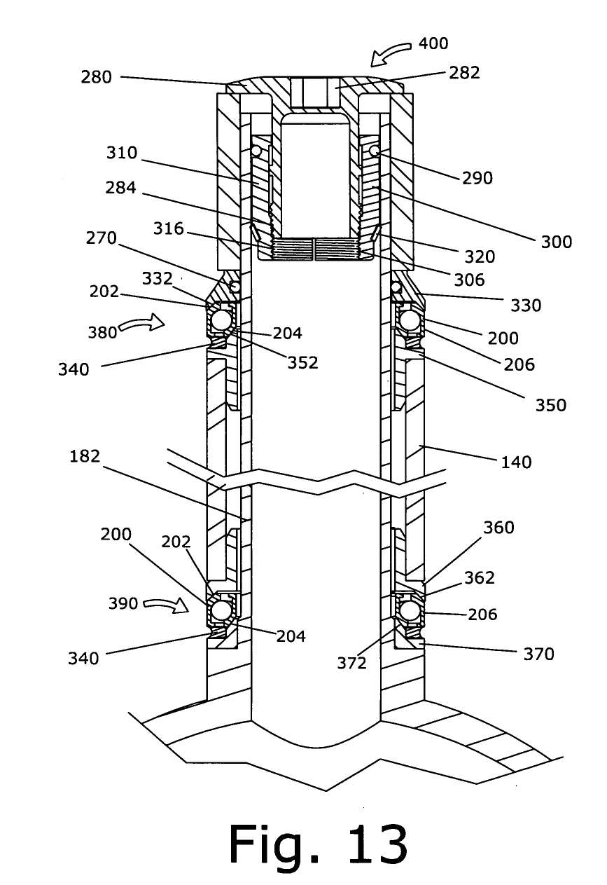

A novel preload assembly 400 is comprised of a threaded cap 280 made of aluminum, two expansion shells 300 and 310 molded out of a thermoplastic such as Nylon, an o-ring 290, and an expansion split ring 320 made of steel. Preload assembly 400 weighs about 19 grams compared to prior art preload assemblies weighing between 30 and 50 grams. Note that cap 280 has an integral thread 284, and that the shaft and thread have an outer diameter of 14.5 mm. Cap 280 can be made of aluminum or other metal that is softer than steel because thread 284 has such a large diameter. Shells 300 and 310 have threads 306 and 316 that engage with thread 284 (shown in FIG. 13). Thread 284 is tapered so that shells 300 and 310 are expanded when cap 280 is tightened.

When preload assembly 400 is pushed into steerer 182, o-ring 290 and expansion ring 320 provide enough friction against steerer 182 that when cap 280 is turned, shells 300 and 310 are fixed relative to steerer 182. Another purpose of expansion ring 320 is to grab the inside of steerer 182 so that cap 280 pulls steerer 182 upwards, preloading bearing assemblies 380 and 390. Expansion ring 320 is preferably made of steel for use with aluminum steerer 182, or is made of a softer material when used with a carbon fiber steerer 182 so as to not cause damage to the steerer. Alternatively, for a carbon fiber steerer 182, expansion ring 320 can have a dull edge that cannot dig into the steerer and cause damage.

The handle bars and stem 50 are clamped in a manner that is similar to the loose ball system shown in FIG. 1. Thus, the handle bars are connected to fork 180 so that the front wheel can be turned by turning the handle bars.

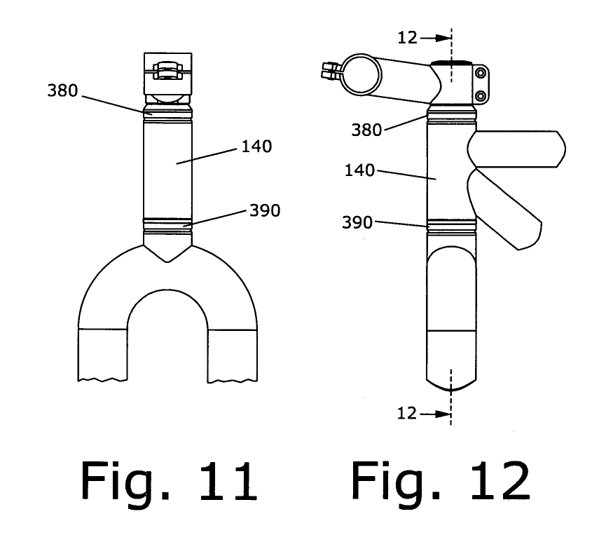

FIG. 11 is a front view of the assembled steering bearing assembly shown FIG. 10. It can be seen that the frontal profile of bearing assemblies 380 and 390 is substantially the same as head tube 140, resulting in improved aerodynamics and aesthetics. Bearing assemblies 380 and 390 are noticeably smaller than bearing assemblies 220 and 230 shown in FIG. 3, and bearings assemblies 240 and 250 shown in FIG. 5. Note that the cartridge bearings used in assemblies 380 and 390 are the same as the cartridge bearings used in bearing assemblies 240 and 250, without any loss in strength or durability. In fact, bearing assemblies 380 and 390 have far better sealing than prior art bearing assemblies, and improved sealing will lead to improved durability.

FIG. 12 is a side view of the steering bearing assembly shown in FIG. 11. Note the relative size of bearing assemblies 380 and 390 compared to head tube 140, and compared to prior art bearing assemblies.

FIG. 13 is a cross sectional view of the steering bearing assembly shown in FIG. 12. Ring 370 is press fit onto steerer tube 182 and has an annular flange 372 that contacts bearing surface 204. Ring 360 has an annular flange 362 to contact bearing surface 202. A seal 340 seals outer race 206 to ring 370. Direct contact between ring 360 and outer race 206 provides sealing between these components. Similarly, ring 330 has an o-ring 270 and an annular flange 332 that contacts bearing surface 202 and ring 350 has an annular flange 352 to contact bearing surface 204. A seal 340 seals outer race 206 to ring 350. Direct contact between ring 330 and outer race 206 provides sealing between these components. Note that the outer race 206 of cartridge bearing 200 is exposed, and that the outer diameter of rings 330, 350, 360, and 370 are about the same size as the outer diameter of bearing 200. The upper and lower bearing assemblies 380 and 390 are preloaded by preload assembly 400 as described in FIG. 10, and clamped in a manner that is similar to the prior art cartridge bearing system shown in FIGS. 1 and 2. As shown, thread 284 is tapered so that shells 300 and 310 with threads 306 and 316 are expanded when cap 280 is tightened via hex 282, and o-ring 290 and expansion split ring 320 are pressed firmed against the inner wall of steerer 182.

FIG. 14 is a front view of alternative embodiment preload assembly 460 is comprised of a threaded cap 470 and a rubber band 480.

FIG. 15 is an exploded perspective view of alternative embodiment preload assembly 460. There is a threaded cap 470 and a rubber band 480.

FIG. 16 is a cross sectional view of alternative embodiment preload assembly 460 shown in FIG. 14. Rubber band 480 expands when threaded cap 470 is tightened because of conical threads 486. When preload assembly 460 is first pushed into the steerer tube 182 (not shown), ribs 482 and 484 of rubber band 480 provide enough friction against the inner walls of steerer tube 182 that rubber band 480 is relatively fixed to steerer tube 182. As threaded cap 470 is tightened, rubber band 480 expands to create full contact with the inner walls of steerer tube 182. The inner diameter of steerer tubes 182 vary depending on the material used and the exact design. Generally, steel and titanium steerer tubes have the largest inner diameter, aluminum has a smaller inner diameter, and carbon fiber has the smallest inner diameter. Also, as has been previously discussed, carbon fiber steerer tubes should not have contact with sharp objects on preload assemblies. A big advantage of alternative embodiment 460 is that it can work with a wide range of steerer tube designs and materials with only a change in the thickness of rubber band 480. It would be very inexpensive to provide preload assembly 460 with a few different thicknesses of rubber band 480 so that this single preload assembly 460 would be compatible with a wide variety of forks 180. Embodiment 460 can also be very light weight and inexpensive to manufacture. As shown, preload assembly 460 weighs only 12 grams if cap 470 is aluminum and rubber band 480 is rubber.

### OTHER EMBODIMENTS

It should be apparent to those skilled in the art that the invention is not limited to the illustrated embodiment, but is susceptible to various modifications. For example, various means may be implemented to provide radial and longitudinal forces between the second bearing and the steerer tube. Instead of a tapered thread 284, a wedged component could be threaded to cap 280 such that the wedged component expands shells 300 and 310. There could be a single expansion shell instead of two shells 300 and 310, or several expansion shells instead of two shells 300 and 310. Two shells 300 and 310 were chosen for simplicity of injection molding. Shells 300 and 310 could be made of aluminum or material other than injection molded thermoplastic. Many other means of expansion can easily be perceived when using a cap 280 that has an integral thread of a size larger than 10 mm in diameter. Depending on the material of the steerer tube, expansion split ring 320 could be replaced by an o-ring or other flexible member.

While rings 330, 350, 360, 370 are shown about the same diameter as bearing 200, the rings could also be somewhat bigger or smaller than bearing 200 and still achieve the advantages described. It will be understood that the assembly may be arranged such that the location of the bearing assembly is inverted. Other variations will be apparent to those skilled in the art. It will thus be evident that there are many additional embodiments which are not illustrated above but which are clearly within the scope and spirit of the present invention. The above description and drawings are therefore intended to be exemplary only and the scope of the invention is to be limited solely by the appended claims and their equivalents.

We claim:

1. A steering bearing assembly for rotatably connecting the front wheel and handle bars to the frame of a bicycle; the assembly comprising:
a head tube of said frame co-axially arranged about a steerer tube affixed to a wheel fork at a first end and affixed to a handle bar stem at a second end, said steerer tube being rotatably secured within said head tube by upper and lower cartridge bearings;
at least one of said upper and lower cartridge bearings having an exposed exterior radial surface in said assembly.

2. A steering bearing assembly for rotatably connecting the front wheel and handle bars to the frame of a bicycle; the assembly comprising:
a head tube of said frame co-axially arranged about a steerer tube affixed to a wheel fork at a first end and affixed to a handle bar stem at a second end, said steerer tube being rotatably secured within said head tube by upper and lower cartridge bearings;
at least one of said upper and lower cartridge bearings being axially supported by at least two flanged ring members having substantially the same diameter as the cartridge bearing it supports.

3. A preloading device for preloading the bearings of a steering bearing assembly, rotatably connecting the front wheel and handle bars to the frame of a bicycle;
the preloading device comprising:
a cap with an integral threaded member extending therefrom into a steerer tube; and
an expansion member threadably engaged with said threaded member for expanding into frictional engagement with said steerer tube upon rotation of said cap.

4. The steering bearing assembly recited in claim 2 further comprising a plurality of annular seals, at least one such seal located immediately adjacent each said cartridge bearing in contiguous axial engagement therewith for preventing contamination of the corresponding cartridge bearing.
